(19) United States
(12) Patent Application Publication
(10) Pub. No.: US 2018/0304608 A1
(43) Pub. Date: Oct. 25, 2018

(54) METHOD AND SYSTEM FOR PRODUCING COMPOSITE STRIPS OR COMPOSITE SHEETS

(71) Applicants: THYSSENKRUPP STEEL EUROPE AG, Duisburg (DE); BWG BERGWERK- UND WALZWERK-MASCHINENBAU GMBH, Duisburg (DE)

(72) Inventors: Andreas NOE, Kerken (DE); Klemens HEERMANN, Dorsten (DE); Thomas VON DER OHE, Leverkusen (DE); Stella JASSEN, Duesseldorf (DE); Andreas KLARE, Luenen (DE); Klaus-Peter KOCH, Schwelm (DE); Gerold RASPUDIC, Kreuztal (DE); Markus RUDACK, Aachen (DE); Josef SCHNEIDER, Wenden (DE)

(21) Appl. No.: 15/767,589

(22) PCT Filed: Oct. 18, 2016
(86) PCT No.: PCT/EP2016/074945

§ 371 Date: Apr. 20, 2018

(30) Foreign Application Priority Data
Nov. 5, 2015 (DE) 10 2015 118 970.4

(51) Int. Cl. B32B 41/00; B32B 15/088; B32B 37/06; B32B 37/20; B32B 15/18

(52) U.S. Cl. CPC B32B 41/00; B32B 15/088; B32B 37/06; B32B 2605/00; B32B 15/18; B32B 2250/40; B32B 2311/24; B32B 37/20

(57) ABSTRACT

The invention relates to a method of making composite strips and composite sheets of at least one first outer layer (1) of metal, one second outer layer (2) of metal, and at least one core layer (3) of plastic between the outer layers (1, 2) and bonded unitarily thereto, a first metal strip (4) for the first outer layer (1), a second metal strip (5) for the second outer layer (2), and a plastic web (6) for the core layer (6) being laminated together and continuously bonded unitarily into a composite strip by application of pressure and/or heat, the first metal strip (4) and the second metal strip (5) being heated before the lamination and/or during the lamination, characterized by the fact that, after lamination and bonding of the metal strips (4, 5), an actual transverse curvature of the composite strips is measured, and that the temperature of the first metal strip (4) and/or of the second metal strip (5) is carried out before the lamination and/or during the lamination as a function of the actual transverse curvature. Furthermore, the invention relates to a system for carrying out the method with a transverse curvature sensor (15).

The present invention relates to a method of making a composite strip or sheet each formed by of at least one first (for example lower) outer layer of metal, one second (for example upper) outer layer of metal and at least one core layer of plastic between the outer layers and bonded unitarily to the outer layers, a first metal strip for the first outer layer, a second metal strip for the second outer layer and at least one plastic web (for example plastic film) for the core layer being merged and bonded to one another under (continuous) application of pressure and/or heat unitarily, the first metal strip and the second metal strip being heated prior to and/or during the lamination.

Such metal-plastic composite sheets or sandwich panels are for example used in vehicle manufacturing. On the one hand, the metal-plastic composite sheets replace conventional steel sheets and, on the other hand, aluminum sheets are on the one hand lighter than steel sheets but on the other hand are more cost effective than aluminum sheets. To this end, the outer sheets for example have a thickness in the range of 0.1 mm to 1 mm and the plastic core layer has for example a thickness of 0.05 mm to 3 mm. Such composite sheets are widely used in the automotive industry, for example as body panels for the outer skin, but also as structural and reinforcement parts. The sandwich panels are characterized by a high bending and buckling stiffness and moreover they have good forming properties, so that they are perfectly processable into body parts. In addition to weight and cost reduction, such sandwich panels also improve acoustic properties and thermal insulation.

During manufacture cold-rolled steel sheets for example typically, which are annealed, finished, and galvanized, are first provided for the outer sheets. The outer sheets manufactured in such a way are then laminated together as a first upper outer layer and as a second lower outer layer by interposing the plastic web and are connected under pressure and/or heat to one another in that the plastic core layer is bonded to the upper outer layer as well as also to the lower outer layer unitarily.

A method of making a composite strip or sheet, for example, is known from DE 10 2013 110 282. In this case, the two outer sheets should be formed from a metal sheet whose surfaces have different roughnesses. The plastic layer should be of polyamide, polyethylene, or a mixture of polyamide and polyethylene. The finished metal strip is first pretreated in one or a plurality of processing stations prior to the one-sided application of the plastic layer. In this way, the strip is for example degreased and/or cleaned with an alkali in a processing station. In a following processing station, the strip surface is passivated in one or a plurality of chemical pretreatment baths and thus prepared for coating. Moreover, there may be a processing station for the one-sided application of a bonding agent or adhesive. After this pretreatment, a plastic layer is optionally applied to the face of the strip possibly carrying the bonding agent or adhesive. The plastic layer can for example be laminated in the form of a prefabricated plastic film onto the strip with for example a laminater having pressure rollers, and at least one of the rollers of the laminater can be heated. After application of the plastic layer, the strip coated on one face passes through a cooling and/or drying device. Subsequently, the strip is wound into a coil and temporarily stored, or it is further transported directly to a device for application a outer sheet or a outer sheet is coated on one face with a plastic layer. In this downstream device two product strips are then for example brought together, each consisting of a outer sheet and a plastic coating, the two semis being unwound from the decoilers and supplied to a pair of rollers in such a way that the two plastic layers of the semifinished strips face each other and abut each other. Immediately before the semifinished strips are introduced into the nip defined by the rollers, the plastic layers of both semifinished strips are activated by the agents acting from the plastic surface face (see DE 10 2013 110 282).

A similar method of making composite sheets is described in DE 10 2013 013 495 [US 2016/0193779]. In this instance, the activation of the plastic layer of the semifinished strips takes place directly from the face of the semifinished strip coated with plastic.

In DE 10 2011 015 071 [US 2014/0178633) and DE 10 2012 106 206 [US 2015/0202844] such sandwich panels are described in which the plastic layer consists of fiber-reinforced plastic.

Alternatively, EP 2 193 021 describes a sandwich panel, in which the plastic core layer is designed as a foam layer, which has a polyamide-polyethylene blend.

Overall, there is a need to manufacture composite sheets of the type described above that are of a high quality in an economical manner.

Thus, in principle there is the possibility that, while making the sandwich strip, undesirable transverse curvatures form, which are also referred to as a crossbow. This is where the present invention comes into play.

Incidentally, DE 689 26 006 [U.S. Pat. No. 4,994,130] discloses the manufacture of a composite sheet: a thermoplastic resin layer in the form of a solid layer is used between two aluminum or iron layers. In order to achieve high surface quality, high tensile stresses are applied to the aluminum or iron layers when they are fed to hot press rolls.

Finally, DE 101 24 836 [US 2002/0174699] relates to the elimination of transverse curvatures in metal strips, with the aid of an adjustable correction roller.

The present invention has the object of further developing a method of the type described above in such a manner that the composite strip or sheet can be manufactured economically with high quality and, in particular, free of transverse curvature. To this end, a system is also to be created that enables economic manufacturing of the composite strips of high quality and, in particular, free of transverse curvature.

In order to achieve this object, in a generic method of the type described above, the invention teaches that after lamination and bonding the metal strips, an actual transverse curvature of the composite strip is measured and that the temperature of the first metal strip and/or the second metal strip is controlled or adjusted before the lamination and/or during the lamination as a function of the actual transverse curvature.

In this instance, the present invention is based on the discovery that undesirable transverse curvatures may result in the manufacture of composite strips, if, in the course of unitary bonding of the metal strips by interposing the plastic web and consequently in the lamination process the temperatures of the outer sheets or outer layers are not the same. This is owing to the fact that for the lamination and bonding (for example in a heated calender), the temperature is homogenized in the sandwich panel. As long as for example the lower outer strip prior to lamination is colder than the upper outer strip, it will heat when bonding (for example in the calender), and optionally in the post-heating furnace, relative to the upper outer strip. This leads to a longitudinal expansion of the lower outer sheet in the width direction relative to the upper outer strip. The difference in length between the two outer strips thus leads to a barrel-shaped transverse curvature. According to the present invention, such transverse curvatures are now not eliminated, as is often customary with metal strips, by a subsequent curvature correction, but according to the present invention, a controlled temperature regulation of the metal strips occurs prior to the lamination and/or during the lamination, in order to avoid the formation of transverse curvatures from the start. According to the present invention, this however is not achieved in that the two metal strips are heated in the preheaters always up to exactly the same target temperature. This is because, prior to lamination, for example in a calender, the strips, after the preheaters pass through open spaces that are not necessarily the same length and in which the same conditions do not necessarily prevail. Moreover, wrapping of the strips in the lamination device, which for example can be a calender having rollers, can be different. In so doing, a simple control of the strip temperature could result in transverse curvatures remaining in the sandwich strip. According to the present invention, for this reason, the metal strips are not simply preheated to identical temperatures, but any resulting transverse curvatures are detected by way of measurement techniques at a predetermined distance downstream of where they merge, and the temperature regulation of the metal strips is carried out selectively as a function of the measured transverse curvature. This results in that, to eliminate transverse curvatures, different temperatures are optionally also set in a targeted manner in the two metal strips.

Particularly preferably, the transverse curvatures are adjusted in a closed control loop to a predetermined desired transverse curvature, the target transverse curvature preferably having the value zero (optionally with a predetermined tolerance range). As the manipulated variable of such a control loop, preferably the temperature of the first metal strip and/or of the second metal strip is then regulated prior to the lamination or during the lamination. This means that if the measured actual transverse curvature deviates from the target transverse curvature, a correction signal for the manipulated variable, that is the temperature regulation, is generated.

For temperature regulation or for modifying the temperature of the respective metal strip prior to lamination, one or a plurality of operating parameters of the respective preheater can be adjusted. The preheater for example may be a furnace, preferably a strip flotation furnace, so that the circulating air temperature in the furnace and/or the circulating air fan speed can then be used for changing the temperature. These parameters can be adapted quickly and are thus very good for varying the temperature or for varying the strip. At an overarching level, it is ensured that the strip temperatures are within a temperature range that ensures a flawless adhesion of the two outer strips to the core layer during lamination and bonding, for example in a calender. Depending on the materials used, the strip temperatures may be in a temperature range of, for example 190° C. to 250° C., for example 200° C. to 240° C., particularly preferably 210° C. to 230° C.

As an alternative to varying the strip temperature via the preheaters (for example strip flotation furnaces), the temperature can also be adjusted via the lamination device, for example, a temperature-controllable roller assembly (for example a calender). This is because the metal strips are preferably laminated together by interposing the plastic web between rollers of a roller assembly, for example a calender. For temperature control or for regulating the temperatures of the metal strips, the temperature of one or both rollers can then be varied or adjusted. In this way, it is customary in practice to heat up calender rollers internally using a suitable medium, for example thermal oil. In this way, the manipulated variable can also be varied in this region of the system.

The invention therefore focuses on influencing the temperature of one or both metal strips before or during the lamination of the metal strips, provided that the manufactured sandwich panel is free of transverse curvature or that it has a predetermined transverse curvature (which may possibly be zero). As a function of a measured actual transverse curvature, measures are therefore subsequently taken to vary the strip temperature of the strip or strips, it not being necessary to exactly set predetermined strip temperatures or even adjust the temperatures to specific target temperatures. Accordingly, the strip temperatures in the described control loop do not constitute the control variable or the set-point value, but the manipulated variable, because by varying the strip temperature, the actual transverse curvature value is made into the target transverse curvature value.

To this end, it can be advantageous to detect the temperature of the first metal strip and/or the second metal strip by measurement techniques, for example using sensors. In this instance, the sensor can be a sensor operating without contact, for example a pyrometer, or also a sensor operating with contact, for example a contact thermometer.

Although, in the context of the present invention, the concern is primarily to adjust the transverse curvature to a predetermined set-point value, the temperature being used as a manipulated variable, the detection and subsequent measurement of the temperatures is advantageous. On the one hand it may be useful to specify certain target temperatures when starting the process, and on the other hand the temperature measurement is also used for control purposes. In this way, temperature detection can also ensure that not only the predetermined transverse curvature (for example zero) is achieved, but that the strip temperatures are within a temperature range that ensures a flawless processing of the plastic material and a flawless adhesion of the two outer strips to the core layer.

As described above, it is advantageous to measure the actual transverse curvature after lamination the metal strips by interposing the plastic web. It is possible to measure the actual transverse curvature at a predetermined distance downstream of the lamination device, for example downstream of the calender. The composite after lamination and bonding in the calender is then preferably finished in a heating and pressing device. Such a heating and pressing device can at least have one heater (for example a strip flotation furnace) and a pressing device, for example another calender. Also, in such a heating and pressing device or in a post-heating furnace provided to this end, a further temperature equalization between possible temperature differences of the metal strips can be done. Nevertheless, it may be advantageous to measure the actual transverse curvature upstream of the heating and pressing device and thus upstream of the post-heating furnace. As a result, it is within the scope of the present invention that the actual transverse curvature is measured after lamination and bonding and before passing through the heating and pressing device connected downstream. This has the advantage that the actual transverse curvature is measured relatively right after lamination, so that the control dead time or down time length is minimized. Within the context of the present invention, it is however also optional to measure the actual transverse curvature downstream of the post-heating furnace or in the heating and pressing section or after the heating and pressing section and to adjust this measuring value to the target transverse curvature. Moreover, it is possible to measure the actual transverse curvature both between the lamination and the post-heating furnace as well as downstream of the post-heating furnace or downstream of the heating and pressing section, so that then a superimposed control can be implemented.

The values for the manipulated variable to be adjusted in the event of deviation of the actual transverse curvature from the target transverse curvature can be determined using a mathematical model including at least the strip thickness, the width of the strip, the thermal expansion coefficient of the metal strips, and/or the temperature difference between the metal strips.

In principle, for correcting the transverse curvature, it is possible to vary the temperatures of the two outer strips. It however suffices to vary only the temperature of one of the strips as a manipulated variable for the control process. In this way, for example, one of the outer strips can have the temperature (fixedly) specified by the operation of the preheater, and to avoid transverse curvature, then only the temperature of the other metal strip is “adapted”, so that by appropriately varying the temperature of this other metal strip, the transverse curvature is adjusted to the desired value, for example zero.

The subject of the present invention is also a system for making a composite strip or sheet of the described type. Such a system has at least one preheater for the first metal strip and a second preheater for the second metal strip and at least one lamination device in which the metal strips are laminated together with interposition of a plastic web. The lamination device can for example be a roller assembly, for example as a calender having at least two (temperature-controlled) rollers. The system according to the present invention is characterized by at least one of the transverse curvature devices connected downstream of the lamination device for measuring an actual transverse curvature of the composite strip. Moreover, a control and/or adjusting device is provided that can adjust the temperature of the first metal strip and/or of the second metal strip before the lamination and/or during the lamination as a function of the actual transverse curvature.

In this instance, the transverse curvature sensors are preferably noncontacting sensors. To that extent, devices known from the prior art for determining transverse curvatures (for example from the field of metal-strip treatment) can be used. In this way, for example optical sensors, for example lasers, are used that perform a laser distance measurement. To this end, for example laser distance sensors, in which a plurality of lasers are fixedly distributed over the width of the strip. Alternatively, one can use laser distance sensors having one or a plurality of lasers that is/are can traverse across the width of the strip, for example on a slide. Finally, it is also possible to use laser sensors whereby at least one laser beam having suitable optical elements is guided transversely to the travel direction of the strip over the belt.

Preferably, the system upstream of and/or in the lamination device has a first temperature sensor for the first metal strip and a second temperature sensor for the second metal strip.

It is within the scope of the present invention to supply the plastic web directly in the course of lamination the metal strips, so that the plastic web is optionally introduced into the gap between the two converging metal strips. The metal strips and the interposed plastic web are thus laminated together simultaneously in this first embodiment, and the lamination is preferably carried out in a lamination device, a laminater, for example a roller assembly that has at least two (heated) rollers forming a nip.

In a modified second embodiment, lamination of the metal strips and the plastic web may however also be carried out in at least two stages. To this end, the laminater preferably has a first laminater that merges the plastic web with the first metal strip (for example the lower metal strip), and a second laminater where the second metal strip (for example the upper metal strip) is laminated together for example with the plastic web on or at the first metal strip. It is therefore within the scope of the present invention to feed the first metal strip (for example the lower metal strip) and merge the plastic web with the first metal strip, so that the plastic web for example is laminated onto the first metal strip. Subsequently, the second metal strip is then fed so that in the second laminater a second laminating or laminating process is carried out. In this second embodiment, the transverse curvature measurement is carried out downstream of the second laminater.

The metal strips laminated together with interposition of the plastic web and thus the produced composite is preferably finished in a heating and/or pressing apparatus. To this end, the heating and pressing device can on the one hand have a heater, for example a further continuous reheating furnace or a post-heating furnace, and on the other hand, a separate pressing device connected downstream from the heater that is for example formed by a roller assembly or a calender. Optionally, a further heater and/or cooler can be connected to the pressing device. To this end, a transverse curvature sensor can be between the laminater and the heating and pressing device. Alternatively or additionally, a transverse curvature measurement may be made at the heating and pressing device (for example downstream of the post-heating furnace) or downstream of the heating and pressing device.

The metallic outer sheets preferably have a thickness of 0.1 mm to 1 mm, preferably 0.2 mm to 0.6 mm.

The intermediate layer of plastic preferably has a thickness of 0.05 mm to 3 mm, for example 0.3 mm to 2 mm. In this instance, thickness of the intermediate layer refers to the thickness of the intermediate layer in the finished product and thus within the composite sheet.

The plastic web is preferably formed as a plastic film. The plastic web may for example be of thermoplastic plastic, for example, from polyethylene, polypropylene and/or polyamide. Within the context of the present invention, plastic material or plastic web refers also to plastic webs or plastic materials, in which further particles or the like, for example fibers, are integrated and thus are in particular fiber-reinforced plastics or plastic webs. Hence, webs with plastic material as a component or manufactured on the basis of plastic are also included. Moreover, a plurality of plastic webs, for example two plastic webs, can be between the outer layers.

It is preferred to use thermoplastic materials having relatively high melting points, to then enable in the course of applying and further processing, processing processes of the composite strip or sheet at higher temperatures, for example within in the context of a lacquering.

In this way, plastic webs of a polyethylene-polyamide compound core having a melting temperature of more than 200° C., for example 200° C. to 250° C., preferably about 220° C., can be used for the core layer.

In the following, the present invention is described in further detail with reference to a drawing illustrating only one embodiment. In the figures,

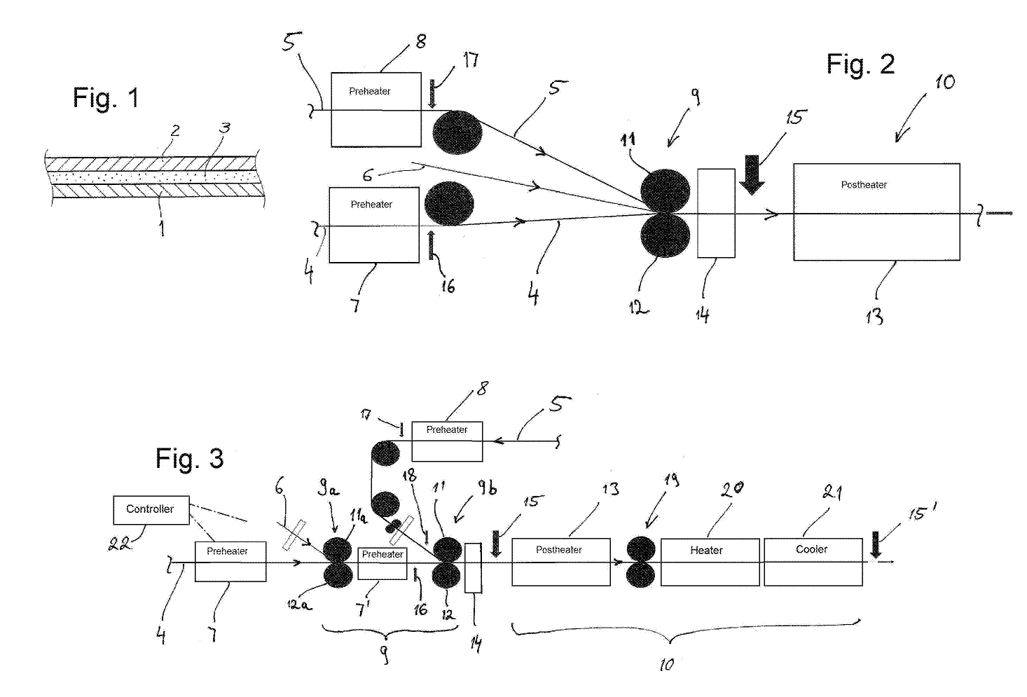

FIG. 1 is a simplified cross section through a composite strip or composite sheet;

FIG. 2 is a greatly simplified schematic view of a system for making a composite strip; and

FIG. 3 shows a modified embodiment of the system as in FIG. 2.

The system illustrated in FIGS. 2 and 3 enables the manufacture of a composite strip or sheet that are made of at least one lower outer layer 1 of metal, one upper outer layer 2 of metal, and at least one core layer 3 of plastic between the outer layers 1, 2, the outer layers 1, 2 being bonded unitarily to the plastic core layer 3 (see FIG. 1).

For making such composite strips according to FIG. 1, a first metal strip 4 for the lower outer layer and an upper metal strip 5 for the upper outer layer and a plastic web 6 for the core layer are thus supplied to the systems of FIGS. 2 and 3. The first metal strip 4, the second metal strip 5, and plastic web 6 are continuously laminated together and continuously bonded to one another unitarily using pressure and/or heat. For the process according to the present invention, the metal strips 4 and 5 are thus the starting material for making a composite strip. These are for example strips of steel, for example electrolytically galvanized and optionally oiled steel strips. Alternatively, strips of aluminum or other metals can however also be used. Preferably, such metal strips 4, 5 can first be pretreated in that they are continuously coated on one face with an adhesive agent. This is not shown in the figures.

The system illustrated in FIGS. 2 and 3 as a rule has at least one unillustrated unwinder for the first metal strip 4 and an also unillustrated unwinder for the second metal strip 5 and, moreover, an also unillustrated unwinder for the plastic web 6. In addition, a rewinder may be provided for the finished composite strip. This is also not shown.

Furthermore, the system has a first preheater 7 for the first metal strip 4, a second preheater 8 for the second metal strip 5, and a laminater 9 in which the metal strips 4 and 5 are laminated together and connected to one another. A heating and pressing device 10 downstream of the laminater 9 finishes the bonding between outer sheets 4 and 5 and the interposed plastic web.

Here, the preheater 7 and the preheater 8 are furnaces, for example strip flotation furnaces. In them, the metal strips 4 and 5 are preheated to a specific temperature.

Here according to FIG. 1, the laminater 9 is a roller assembly or calender having an upper roller 11 and a lower roller 12, and these rollers 11 and 12 can be heated. In the embodiment according to FIG. 1, only one post-heating furnace 13, which also can be a strip flotation furnace, is illustrated as the heating and pressing device 10.

To this end, FIG. 2 shows a first embodiment of the present invention where the two the metal strips 4 and 5 and the plastic web 6 are simultaneously laminated together and bonded to each other with the plastic web 6 being fed directly to where the metal strips 4 and 5 merge, the plastic web thus being introduced into the gap between the two converging metal strips.

Moreover, the metal strips 4 and 5 in the system can be locally connected in another strip connecting device 14 when starting up the process at a strip leading end. Such a connection of the two strips takes place in a start-up process, particularly preferably without interposed plastic web. The connection can be done for example by punching, riveting (clinching), welding, and/or adhesive bonding. Such strip connectors are known from process lines for making metal strips. In the case of the described system, the strip connectors are optionally at the laminater or in the travel direction of the strip downstream of the laminater and upstream of the heating and/or pressing device. With this additional local strip connection at the leading end of the metal strips or at the leading end of the strip of one of the metal strips, a delamination of this region downstream is prevented by the laminating line. The start-up process can overall be optimized to ensure that, when passing through the laminating line and in particular the heating and optionally pressing units from the upstream end, the two surfaces of the continuous workpiece are formed by metal strips and not by the plastic strip.

According to the present invention, it is now particularly important that the laminater 9 be downstream of a transverse curvature sensor 15 that can measure an actual transverse curvature of the composite strip manufactured in the laminater. According to the present invention, the temperature of the first metal strip 4 and/or of the second metal strip 5 is controlled before the lamination and/or during the lamination as a function of the measured actual transverse curvature. According to the present invention, potentially resulting transverse curvatures in the composite strip subsequently are thus not corrected by suitable measures, but the formation of transverse curvatures is instantly inhibited by suitably influencing the temperature regulation of the metal strips, and that is preferably by control engineering measures.

To this end, the system has a controller or adjusting device, which is not illustrated, that regulates the temperature of the first metal strip 4 and/or the second metal strip 5 before the lamination and/or during the lamination as a function of the actual transverse curvature.

Particularly preferably, the transverse curvature is adjusted in a closed loop control to a predetermined desired transverse curvature, the target transverse curvature preferably specifying the value zero. As the manipulated variable of such a control loop, the temperature of the first metal strip and/or the second metal strip is regulated prior to the lamination or during the lamination. Hence, if within the course of the measuring a deviation of the measured actual transverse curvature from the specified target transverse curvature (for example zero) is detected, the adjusting device generates a correction signal for the manipulated variable so that the temperature of the first metal strip and/or of the second metal strip is varied. With the aid of a closed loop control, the actual transverse curvature can then be corrected to the specified target transverse curvature.

For regulating the temperature and, for this reason, the temperature of the respective metal strip in the course of an adjustment process, for example, the operating parameters of the preheater and thus of the furnace 7 and/or 8, can be adjusted.

Alternatively, for regulating the temperature and, for this reason, the temperature of the respective metal strip, the temperature of the rollers 11 and 12 of the laminater can be varied or adjusted.

It is always ensured that the temperatures of the metal strips are set in such a manner that, within the course of bonding, a composite strip free of transverse curvature can be produced.

In this instance, the temperatures of the two metal strips do not necessarily have to be identical because the metal strips, after leaving the furnaces 7 and 8, pass through different spaces and also the extent of wrap around the rollers 11 and 12 are not identical. Thus, within the context of the method according to the present invention, neither absolute temperatures of the metal strips nor, in particular, identical temperatures are decisive, but the temperatures merely have to be set relative to each other so that a composite strip free of transverse curvatures results in the composite. This is because the temperature in the sandwich panel is homogenized during the lamination (in the calender 9) and/or after lamination. To the extent that the lower outer strip 4 is colder before laminating than the upper outer strip 5, it would be heated in the calender 9 and/or in the post-heating furnace 13 relative to the upper strip, and this would result in a longitudinal expansion of lower outer strip 4 in the direction of the strip width relative to upper outer strip 5. The difference in transverse width between the two outer strips results in a barrel-like transverse curvature that is prevented according to the present invention by a targeted variation in temperature before or during lamination. In this instance, it is within the scope of the present invention that a first temperature sensor 16 is provided downstream of the first furnace 7 and that a second temperature sensor 17 downstream of the second furnace 8. Here according to FIG. 2, a transverse curvature sensor 15 is spaced downstream from the laminater 9 and upstream of the heating and pressing device 10 or downstream of the postheating furnace 13. Alternatively, it is however also within the scope of the present invention to provide a transverse curvature sensor 15 downstream of the post-heating furnace 13 or downstream of the heating and pressing device 10.

FIG. 3 shows a modified embodiment of the present invention where the lamination of the metal strips 4 and 5 and of the plastic web 6 is carried out in two steps. To this end, the laminater 9 preferably has a first laminater 9a that laminates plastic web 6 with the first metal strip 4 (for example the lower metal strip), and a second laminater 9b that laminates the second metal strip 5 (for example the upper metal strip) with the plastic web 6 on or at the first metal strip 4. The first laminater 9a, in turn, is a roller assembly or calender having an upper roller 11a and a lower roller 12a. The second laminater 9b, in turn, is a roller assembly or calender having an upper roller 11a and a lower roller 12a. There are also preheaters 7 and 8. Moreover, a further heater 7′ is provided for the first metal strip 4 downstream of first laminater 9a. A transverse curvature sensor 15 that is used in connection with the roller already described in FIG. 2, is downstream of the laminater 9 and, in the shown embodiment, downstream of the second laminater 9b. Optionally, this transverse curvature sensor 15 could also be downstream of the post-heating furnace 13 or between post-heating furnace 13 and calender 19.

This is because the heating and pressing device 10 connected downstream from the laminater 9, here according to FIG. 2, has a heater 10, for example a furnace 13, a pressing device and optionally a further heater, for example a furnace 20, and optionally a cooling device 21 connected downstream. Optionally, an additional transverse curvature sensor 15′ can be downstream from the heating and pressing device 10. This additional transverse curvature sensor 15′ can be used merely for checking purposes. Alternatively, it is also within the scope of the present invention to use this additional transverse curvature sensor 15′ in combination with the transverse curvature sensor 15 for redundant adjustment control.

In turn, a temperature sensor 16 is assigned to the first metal strip 4 and, also, a temperature sensor 17 is assigned to the second metal strip 5. A further temperature sensor 18 can be provided at the second metal strip 5.

Independent from the described differences between the embodiments according to FIGS. 2 and 3, also here according to FIG. 3, an adjustment of the transverse curvature is carried out in that, when the measured actual transverse curvature deviates from

A predetermined target transverse curvature, a correction signal for the manipulated variable is generated, in turn the temperature of the first metal strip and/or of the second metal strip being controlled as a manipulated variable before the lamination or during the lamination.

In this instance, it is categorically possible to influence the temperature regulation of the first metal strip as well as also the temperature regulation of the second metal strip during adjustment. Preferably, only the temperature of one of the metal strips, for example the upper metal strip, is however regulated as the manipulated variable for the adjustment.

1. A method of making a composite strip and composite sheet of at least one first outer layer of metal, one second outer layer of metal and at least one core layer of plastic that is between the outer layers and bonded unitarily, the method comprising the steps of:
feeding a first metal strip for the first outer layer, a second metal strip for the second outer layer, and a plastic web for the core layer to a laminater that continuously laminates the metal strips and plastic web unitarily into a composite strip by application of pressure and/or heat,
preheating the first metal strip and the second metal strip in respective presenters upstream of or in the laminater, and
after lamination and bonding of the metal strips, measuring an actual transverse curvature of the composite strips, and
regulating the temperature of the first metal strip and/or of the second metal strip as a function of the actual transverse curvature upstream of or in the laminater.

2. The method defined in claim 1, wherein the transverse curvature is adjusted by a closed loop control to a specified target transverse curvature.

3. The method defined in claim 2, wherein a value of zero is the target transverse curvature.

4. The method defined in claim 2, wherein a manipulated variable of the control loop is the temperature of the first metal strip and/or of the second metal strip upstream of or in the laminater.

5. The method defined in claim 1, wherein, for temperature regulation of the metal strip before the lamination, one or a plurality of operating parameters of the respective preheater is/are adjusted.

6. The method defined in claim 1, wherein at least one furnace is used as a preheater.

7. The method defined in claim 1, wherein the metal strips are laminated together by interposing the plastic web between the rollers of a calender.

8. The method defined in claim 7, wherein, for temperature regulation of the metal strips, the temperature of the rollers is varied.

9. The method defined in claim 1, wherein the temperature of the first metal strip and/or of the second metal strip is measured by at least one respective sensor.

10. The method defined in claim 1, further comprising the step of:
passing the composite strip after lamination through a heating and pressing device, one or a plurality of transverse curvature measurements being carried out between the laminater and the heating and pressing device and/or downstream of the heating and pressing device.

11. The method defined in claim 4, wherein the values for the manipulated variable to be adjusted in the event of a deviation of the actual transverse curvature from the target transverse curvature are determined using a mathematical model that comprises at least the strip thickness, the width of the strip, the thermal expansion coefficient, and/or the temperature differential between the metal strips.

12. A system for making a composite strip or sheet that is made of at least one lower outer layer of metal, one upper outer layer of metal, and one core layer of plastic that is between the outer layers and that is bonded unitarily thereto, the system comprising
at least one first preheater for the first metal strip,
one second preheater for the second metal strip;
a laminater in which the metal strips are laminated together by interposing a plastic web;
at least one transverse curvature sensor that measures an actual transverse curvature of the composite strip downstream of the laminater, and
a control and adjusting device that controls the temperature of the first metal strip and/or of the second metal strip before and/or during lamination as a function of the measured actual transverse curvature.

13. The system defined in claim 12, wherein the transverse curvature sensor is a sensor operating with or without contact.

14. The system defined in claims 12, further comprising:
a first second temperature sensor for the second metal strip upstream of and/or in the laminater.
